(19) United States
(12) Patent Application Publication
(10) Pub. No.: US 2008/0163364 A1
(43) Pub. Date: Jul. 3, 2008

(54) SECURITY METHOD FOR CONTROLLED DOCUMENTS

(76) Inventor: Andrew Rodney Ferlitsch, Camas, WA (US)

Correspondence Address: MICHAEL BLAINE BROOKS, PC, P.O. BOX 1630, SIMI VALLEY, CA, 93062-1630, US

(21) Appl. No.: 11/616,416

(22) Filed: Dec. 27, 2006

(51) Int. Cl. G06F 17/30; G06F 12/14

(52) U.S. Cl. 726/21; 707/102; 713/193; 707/E17.005

(57) ABSTRACT

The invention, it its several embodiments, pertains to document control, more particularly to tracking and controlling production and destruction of documents. Documents may include softcopies and hardcopies. Typically, each document controlled in the exemplary tracking and control system has its own tracking identifier, so as to enable the system, for example, to distinguish an original document from copies and to distinguish copies from copies.

### BACKGROUND

1. Technical Field—Field of Endeavor

The invention, it its several embodiments, pertains to document control, more particularly to tracking and controlling production and destruction of such documents.

2. State of the Art

Documents, both softcopies and hardcopies, are widely reproduced and distributed today. Many documents, however, are not intended to be freely distributed or reproduced. Methods, systems, and devices that provide tracking or security-related functions are highly desirable. It is also particularly desirable to track when a document is destroyed or copied.

### SUMMARY

In one aspect of the invention, a method of tracking and controlling documents is provided. Each document typically includes one or more pages. The method includes the steps of receiving a new tracking identifier; generating a page of a second document based on a page of a first document, wherein the first document page comprises an old tracking identifier associated with the first document page and the first document, wherein the second document page comprises the new tracking identifier associated with the second document page and the second document, wherein the step of generating further comprises replacing the old tracking identifier with the new tracking identifier; associating the old tracking identifier with the new tracking identifier; and recording the association between the old tracking identifier and the new tracking identifier.

In another aspect, another method of tracking and controlling documents is provided. Each document includes one or more pages. The method includes the steps of determining a tracking identifier embedded in a page of a document, wherein the tracking identifier is associated with the document page; performing a destruction operation on the document page; transmitting the tracking identifier and an indicator indicating destruction of the document page; and recording the tracking identifier.

In another aspect of the invention, a device is provided. This device includes a communication module, a tracking identifier module, and a reproducing module. The communication module is adapted to communicate with a tracking server, receive a new tracking identifier from the tracking server associated with a second document page, and transmit an old tracking identifier associated with a first document page. The tracking identifier module is adapted to determine the old tracking identifier embedded within the first document page. The reproducing module is adapted to generate the second document page based on the first document page by replacing the determined old tracking identifier with the received new tracking identifier, wherein the second document page comprises the new tracking identifier.

In another aspect, a device adapted to be operably coupled to a network is provided. The device includes a tracking identifier module adapted to determine a tracking identifier embedded within a page, a communication module adapted to communicate the determined tracking identifier to a tracking server adapted to maintain tracking identifiers, and a destruction module adapted to perform a destruction operation on the page.

In another aspect of the invention, a system is provided. The system includes a first device and the tracking server. The first device includes a communication module, a tracking identifier module, and a reproducing module. The communication module is adapted to communicate with a tracking server, receive a new tracking identifier from the tracking server associated with a second document page, and transmit an old tracking identifier associated with a first document page. The tracking identifier module is adapted to determine the old tracking identifier embedded within the first document page. The reproducing module is adapted to generate the second document page based on the first document page by replacing the determined old tracking identifier with the received new tracking identifier, wherein the second document page comprises the new tracking identifier. The tracking server includes a tracking communication module adapted to transmit the new tracking identifier and record an association between the old tracking identifier and the new tracking identifier.

### BRIEF DESCRIPTION OF THE DRAWINGS

For a more complete understanding of the present invention and for further features and advantages, reference is now made to the following description taken in conjunction with the accompanying drawings, in which:

FIG. 1 is a functional block diagram illustrating an exemplary tracking and control system embodiment of the present invention;

FIG. 2 is a functional block diagram illustrating another exemplary tracking and control system embodiment of the present invention;

FIG. 3A is a diagram representing a one-page hardcopy document with an embedded tracking identifier, according to an embodiment of the present invention;

FIG. 3B is a diagram representing another hardcopy document, but with multiple pages, according to an embodiment of the present invention;

FIG. 4A is a diagram representing a softcopy document with an embedded tracking identifier, according to an embodiment of the present invention;

FIG. 4B is another diagram representing another exemplary softcopy document with divisions, according to an embodiment of the present invention;

FIG. 5 is a high-level flowchart showing an exemplary process of generating a copy of a hardcopy document, according to an embodiment of the present invention;

FIG. 6 is a high-level flowchart showing an exemplary process of tracking a destroyed or to be destroyed hardcopy document, according to an embodiment of the present invention;

FIG. 7 is a high-level flowchart showing an exemplary process, with a locking code, of tracking a copy of a softcopy document, according to an embodiment of the present invention;

FIG. 8 is a high-level exemplary data flow illustrating copy generation, according to an embodiment of the present invention;

FIG. 9 is a high-level exemplary data flow illustrating document destruction, according to an embodiment of the present invention;

FIG. 10 is a high-level flowchart showing an exemplary process of deleting a softcopy, according to an embodiment of the present invention;

FIG. 11 is a high-level flowchart showing an exemplary process of providing document security or control with locking codes, according to an embodiment of the present invention;

FIG. 12 is a high-level flowchart showing an exemplary document-monitoring process, according to an embodiment of the present invention;

FIG. 13A is a block diagram of an exemplary encrypted softcopy, according to embodiments of the present invention;

FIG. 13B is a high-level flowchart showing an exemplary process of copying and encrypting a softcopy, according to an embodiment of the present invention;

FIG. 14A is a diagram of an exemplary data flow illustrating data being exchanged when an unencrypted softcopy document is to be copied, and the copy is to be stored in encrypted form, according to an embodiment of the invention;

FIG. 14B is a diagram of an exemplary data flow between the reproducing device and the tracking server to perform a viewing operation, according to an embodiment of the invention; and

FIG. 14C is a diagram of an exemplary data flow between the reproducing device and the tracking server to perform a copy operation, according to an embodiment of the invention.

### DETAILED DESCRIPTION OF THE EXEMPLARY EMBODIMENTS

The embodiments of the present invention typically include a tracking server that may be communicatively coupled or connected, e.g., to one or more document- and/or file-generating devices and to document destroying devices in a networked system, in order to receive document tracking identifiers and relate these identifiers to documents, e.g., newly copied or extant documents, or documents that have been confirmed as having been destroyed or generated. The system embodiment of the present invention may also provide diagnostic-related alerts, for example, when the destruction process is abnormal.

The embodiments of the invention may also be adapted to uniquely identify documents, whether softcopies or hardcopies, via tracking identifiers, to control replication or copying of documents, for example, on authenticated media storage, and to track identified and controlled documents that are destroyed. In some embodiments, each page of a document may be tracked, whether such a document includes one or more pages.

The embodiments of the present invention process documents, which may be hardcopy documents or softcopy documents. A hardcopy document, in general, is a printed document in any suitable media, typically paper and other printable media, such as transparencies, overlays, and the like. A softcopy document, in general, is a digital or electronic document. For example, a softcopy document may be embodied as an electronic file, e.g., stored in a computer-readable medium, such as a hard drive or a thumb drive. A file, e.g., a MICROSOFT WORD® document burned in a compact disc (CD) may be construed as a softcopy, while the printout of such a softcopy document may be considered a hardcopy. The embodiments of the present invention process both these types of documents. Softcopies, such as digital files, may be stored in storage media, such as CDs, DVDs, hard drives, thumb drives, and may even be streamed between one processing device to another, such as computers.

### Controlled Hardcopy Reproduction and Destruction

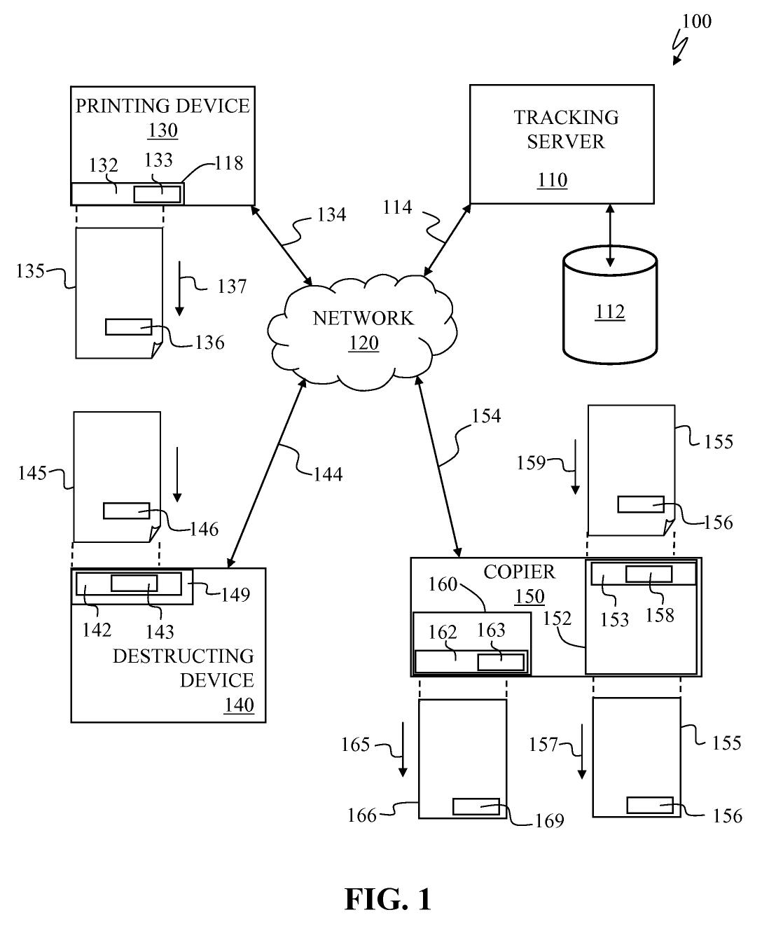

FIG. 1 illustrates an exemplary tracking and control system 100 having a tracking server 110 operably connected or coupled to a database 112, which may be local and/or remote to the tracking server 110. One of ordinary skill in the art will appreciate that the database may be embodied in many forms, such as a relational database management system (RDBMS), flat files, linked lists, and any other database systems. Such a database 112 may be spread over multiple devices and may also be indexed. The tracking server 110 is operably connected to one or more track and control devices, for example via a network segment 114 of a communication and/or data network 120, e.g., a local area network, virtual private network, wide area network, and the Internet. A track and control device may be embodied in many forms, and may function as a reproducing device, a destructing device, or both. A track and control device may be embodied in devices, such as shredders, copiers, facsimile machines, computing devices, and multi-function peripherals.

An exemplary track and control printing device 130, which typically includes a printing subsystem 118 having a processing module 133 and a tracking identifier (ID) printing module printing module 132 for printing and reporting a document tracking identifier, is shown connected to the network 120, for example, via a network segment 134. The tracking identifier printing module 132 may be operably connected to or integral with the printing subsystem 118.

A document 135, particularly a hardcopy document, for example, may be outputted or generated 137 by the printing device 130 having a tracking identifier 136 embedded on the document—such as a bar code, a watermark, or magnetic ink characters printed on the document 135, representing a tracking identifier that may be sent to and/or received from the tracking server 110 and stored in a database 112. The tracking identifier 136 may be a bar code, watermark and/or magnetic ink characters. The bar code may be embodied in any machine-readable representation, which may include, but is not limited to, parallel lines, numbers, dot patterns, concentric circles, and even representations hidden in images. In other embodiments, the tracking identifiers are embedded within a document, e.g., printed, as magnetic ink characters adapted to be read by magnetic ink character recognition (MICR) readers/sensors or as a watermark adapted to be read by an image recognition reader/sensor.

An exemplary track and control document destructing device 140, such as a shredder, is shown connected to the network 120 via a network segment 144, where the document destructing device may include a tracking identifier module 142, such as a barcode scanner/reader module and/or a MICR reader module and/or an image reader module, and a processing module 143 for detecting and/or reporting the destruction of a document 145, particularly a hardcopy, having a tracking identifier 146 to the tracking server 110. A barcode scanning module, embodied as a tracking identifier module, may include a one-sided scanner and may include a magnetic ink character recognition (MICR) scanner module, and may include an image recognition scanner module. The tracking identifier module 142 may include a two-sided scanner for scanning tracking identifier barcodes 146 or watermarks on both sides of a page of a document 145 being processed for destruction. The document destructing device 140 may include a page/document feeder 149 that passes each page of the document 145 on a first side past the barcode or image scanner and then, in the event the barcode or watermark is not detected during the first pass, in a second pass, passes each page of the document of the second, or reverse, side past the barcode or image scanner 142. The destructing device 140 thus may include a single-pass automatic document feeder (SADF) or a reversible automatic document feeder (RADF). The tracking identifier module 142 may include multiple types of reader/sensors/scanners, such as a bar code reader/scanner, image reader/scanner and/or an MICR reader/scanner. The tracking identifier module 142 may also include a two-sided reader for reading tracking identifiers embodied as watermarks on both sides of a page, for example. A tracking identifier printed in magnetic ink may be read by an MICR reader/scanner typically regardless of whether the tracking identifier is printed on the front or back of a page.

An exemplary track and control single-function peripheral, such as a document copier 150, is also shown connected to the network 120 via a network segment 154. The document copier 150 may include a one- or two-sided document feeder 152 having a processing module 153 and a one- or two-sided scanning module 158. The document copier 150 also includes a printing subsystem 160 having a processing module 163 and tracking identifier printing module 162 which may be operably connected to or integral with the printing subsystem 160. The tracking identifier may be printed on one surface or both surfaces of one or more pages of the document. Accordingly, a page or document of pages 155, having a tracking identifier 156 on one or both surfaces of at least one page, may be placed 159 to engage the document feeder 152, and thereafter the document feeder causes the surface indicia of the one or more pages including the tracking identifier 156 to be scanned by the one- or two-sided scanning module 158. The indicia may be images and rendered from printing via the printing subsystem 160 or by other printing subsystems, e.g., the printing subsystem 132 of the printing device 130, of the embodiments of the present invention. The tracking identifier 156 may be processed and the tracking identification may be sent to the tracking server 110. The original document 155, for example, after being scanned using the document feeder 152 may then be outputted 157 from the document feeder 152. The tracking server may also authorize the processing module 163 and/or tracking identifier printing module 162 to output 165 a copy document 166 of the original document 155 having a tracking identifier 169 that may be stored by, and may be issued by, the tracking server 110. Accordingly, a hardcopy 166 of the original document 155 may be outputted or generated 165 having a tracking identifier printed on one or both surfaces of at least one of the pages of the document 166 wherein the original tracking identifier 156 has been filtered and replaced with the new tracking identifier 169 in the copy 166.

In some embodiments, the tracking and control system 100 is operably coupled to a track and control facsimile device, not shown, adapted to receive and transmit faxes. This facsimile device is also operably connected with the tracking server 110 for tracking identifier purposes. A facsimile received by this exemplary facsimile device may print a tracking identifier as part of the received hardcopy document, so as to enable tracking of this document within the tracking and control system 100. In other embodiments, the facsimile document, when transmitting an outbound facsimile, transmits a tracking identifier included on the outbound facsimile document, to enable tracking, if available, by another external tracking and control system, for example. The receiving facsimile machine of this outbound facsimile document thus receives this document with the tracking identifier as part of its document. Other devices, such as reproducing devices, which may be operably connected to the exemplary tracking and control system 100 may include, but are not limited to, format conversion devices, media conversion devices, and filing or archive devices.

The tracking server 110 and the devices 130, 140, 150 operably coupled to the network 120 may communicate with each other via various means, including, for example, via wired or wireless network segments, such as radio frequency, infrared, and/or microwave. The various network segments 120 may also be a combination of wired and wireless network segments. Various protocols and markup languages may also be used, such as transmission control protocol (TCP) over Internet Protocol (IP)-TCP/IP, hypertext transfer protocol (HTTP) with hypertext markup language (HTML), simple object access protocol (SOAP) with extensible markup language (XML), and other communication means adapted to operably connect the tracking server 110 with the other devices within the system 100.

### Controlled Softcopy Reproduction and Destruction

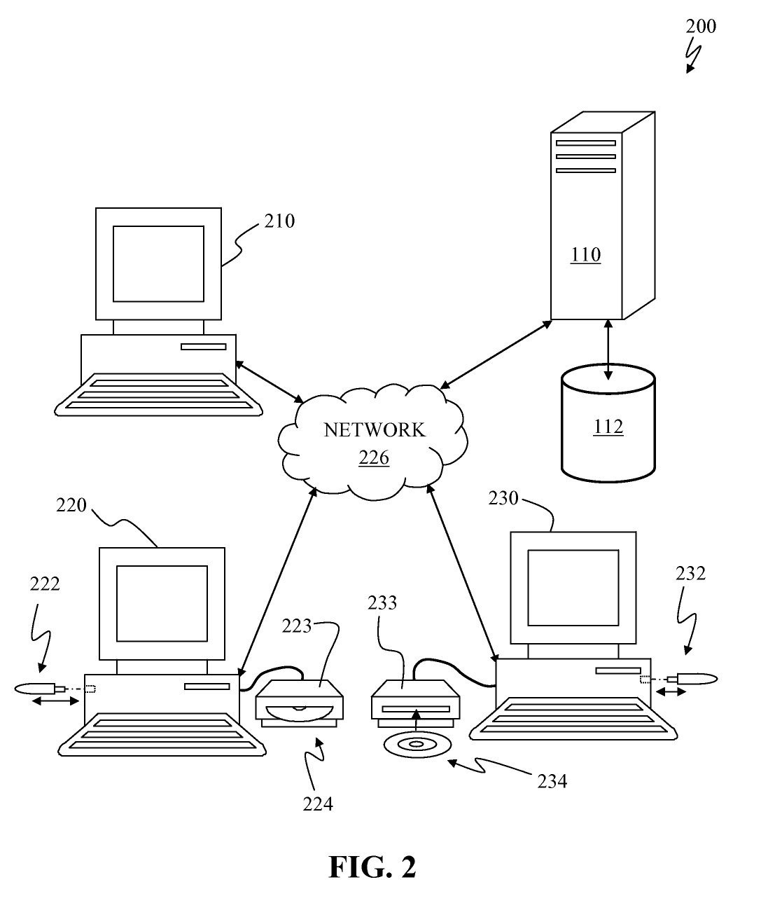

FIG. 2 illustrates another exemplary tracking and control system 200 with processing devices including a tracking server 110, a first processing unit 210, a second processing unit 220 adapted to engage communicatively with removable or disconnectable storage media, such as a thumb drive or other flash memory device 222, and a media writing device 223, such as a CD read/write device or a DVD read/write device, and a conveyance article 224, such a CDRW or DVDRW, and a third processing unit 230 shown adapted to engage communicatively with removable or disconnectable storage media, such as a thumb drive or other flash memory device 232, and a media writing device 233, such as a CD read/write device or a DVD read/write device, and a conveyance article 234, such a CDRW or DVDRW. The devices 210, 220, 230 are communicatively coupled to the tracking server 110 via a data communication network 226, similar to the data communication network shown in FIG. 1.

A softcopy in this exemplary embodiment typically requires an authenticated medium of storage to which the softcopy may be directed. For example, a softcopy reproduction may be made by and within the processing and data storage management of a processing unit and, in this example, particularly by and within the first processing unit 210 where the internal data store is an authenticated media or data storage. In the exemplary operation of a softcopy reproduction, the reproducing device is restricted from outputting the softcopy only to an authenticated media storage, e.g., a file system of a server or a thumb drive. The reproducing device, in this example, typically first queries the target storage medium for a unique storage identifier. If the target storage medium has, and returns to the originator of the query, a unique identifier, the reproducing device may provide the identifier to the tracking server 110. Once the tracking server 110 relates or associates the storage medium's identifier with a tracking identifier, the tracking server 110 may then issue an authorizing communication to the reproducing device that may then output the softcopy to the identified storage medium. In some embodiments, the authenticating step may be performed by the reproducing device having an authorization look-up table and then, once the tracking server 110 receives the authorized target storage medium identifier from the recording device, the tracking server 110 records the related softcopy tracking identifier and storage medium's unique identifier.

The exemplary tracking and control system of the present invention may include devices that process hardcopies, softcopies, or both. In some embodiments, the exemplary tracking and control system may be a combination, e.g., a combination of system 100 in FIG. 1 and system 200 in FIG. 2. In some embodiments, the devices, operably coupled to the tracking server 110 via the network, may also interface and maintain its own database, e.g., a database containing file name/location and tracking identifier association of all controlled documents processed or accessible by that particular device. Various other system architecture and design may be implemented and still be in the scope of the present invention.

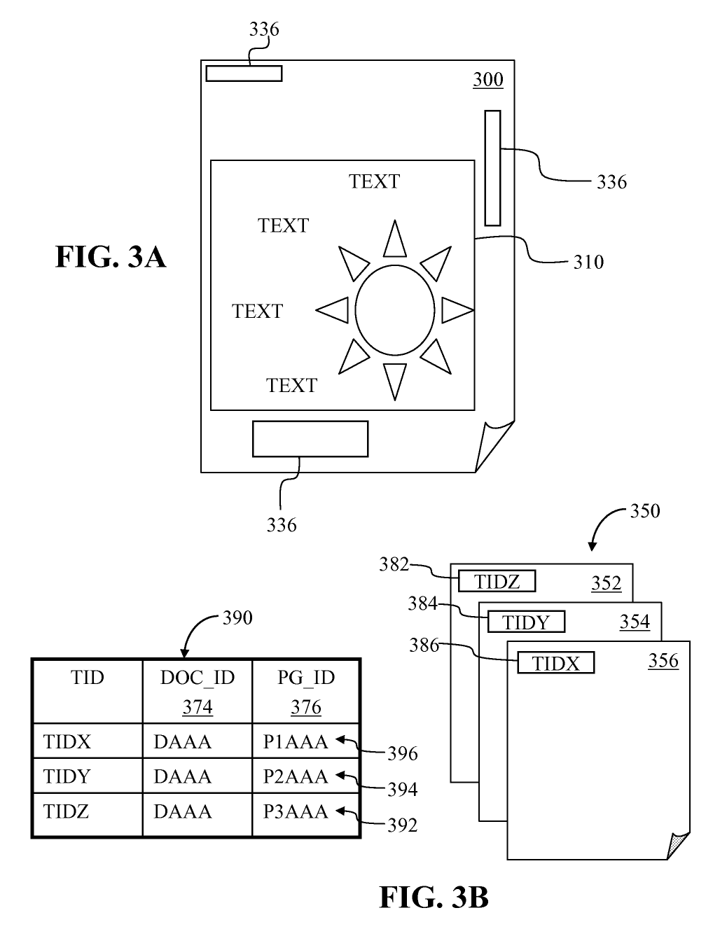

FIG. 3A shows an exemplary hardcopy 300, according to an embodiment of the invention. The exemplary hardcopy 300 is a one-page document that contains document data 310 with both text and graphics. The hardcopy document typically includes at least one tracking identifier 336, which may be embodied as a barcode, e.g., a linear barcode, a stacked barcode, or a 2D barcode. Other identification tags or representations of tracking identifiers, instead of barcodes, may also be used, such as magnetic ink characters, watermarks, digital signatures, or other steganographic signatures/marks, which may be detected by automatic sensors/readers. In some embodiments, the tracking identifiers stored in the database may be represented differently from the tracking identifiers as embedded or included within a document. For example, the tracking identifier stored in a database may be a numerical value, which when embedded on a document, e.g. printed on a hardcopy or embedded within a softcopy, is represented in another way, such as a bar code.

The hardcopy 300 may have one or more of the same tracking identifiers embedded, e.g., printed, on the surface of the page. The exemplary tracking identifier 336 may be printed on one or more surface areas of the hardcopy document, may be oriented in a number of ways, and/or be sized in a number of ways. In some embodiments, the tracking identifier 336 is placed in the margin area or very near an edge of a page, for example. This exemplary hardcopy may be produced by an exemplary printing device 130 or by an exemplary copying machine 150. This exemplary hardcopy 300 is a print-out, for example, on paper, facsimile paper, or on transparency. In some embodiments, there may be multiple tracking identifier types printed on the same surface of a page, for example, one embodied as a bar code, while the other embodied as magnetic ink characters. In other embodiments, a bar code tracking identifier is printed on the top surface of a page, while a magnetic ink character tracking identifier is printed on the bottom surface of the same page.

FIG. 3B shows another exemplary hardcopy document 350, but with multiple pages, according to an embodiment of the invention. A document 350 may have multiple pages, e.g., three pages 352, 354, 356, for example, a MICROSOFT WORD® document may have multiple pages. The tracking identifier of the present invention may be adapted to identify and associate each page of a document to a unitary document 350. The exemplary tracking identifier of the present invention thus may be associated to a document and/or each page of that document, and such associations may be represented or stored 390 in a database. For illustrative purposes, let us assume that a MICROSOFT WORD® document, e.g., a file called “document1.doc” is associated with a document identifier/ID 374, e.g., “DAAA.” Each page 382, 384, 386 of that document typically also has its own page identifier/ID 376, 392, 394, 396, such that association between the document and the page may be derived or determined. In some embodiments, the page ID 376 is derived from the document ID, e.g., the page number is combined with a portion of the document ID, e.g., “P1” indicating page 1, is combined with “AAA” of “DAAA” 374 to obtain a page ID 376, that is “P1AAA” 396.

Each page 352, 354, 356 of the document 350 is typically associated with its own tracking identifier 382, 384, 386. The exemplary first page 356 of the document 350 has a tracking identifier, TIDX 386. This tracking identifier 386, TIDX, is associated with the document 350, via an exemplary document identifier/ID 374, and with the page of that document, via the exemplary page identifier/ID 376, as represented in the exemplary entry 396 in a database. One of ordinary skill in the art will appreciate that association between the tracking identifier and the document and/or page number, as well as the association between a document and its pages, may be embodied in a database in many ways. For example, a different table may be created to store each document and page association and a different table may be created to store each tracking identifier and page association. The second page of the document 354 has an embedded tracking identifier 384, TIDY, represented in the exemplary database as an entry 394, while the third page 352 has an embedded tracking identifier 382, TIDZ, represented also in the database 392.

Each page 352, 354, 356 of the exemplary document 350 typically has its own tracking identifier and document data similar to that in FIG. 3A. Furthermore, there may be multiple tracking identifiers and/or tracking identifier types in each page, with various placement and sizes, similar to the discussion in FIG. 3A.

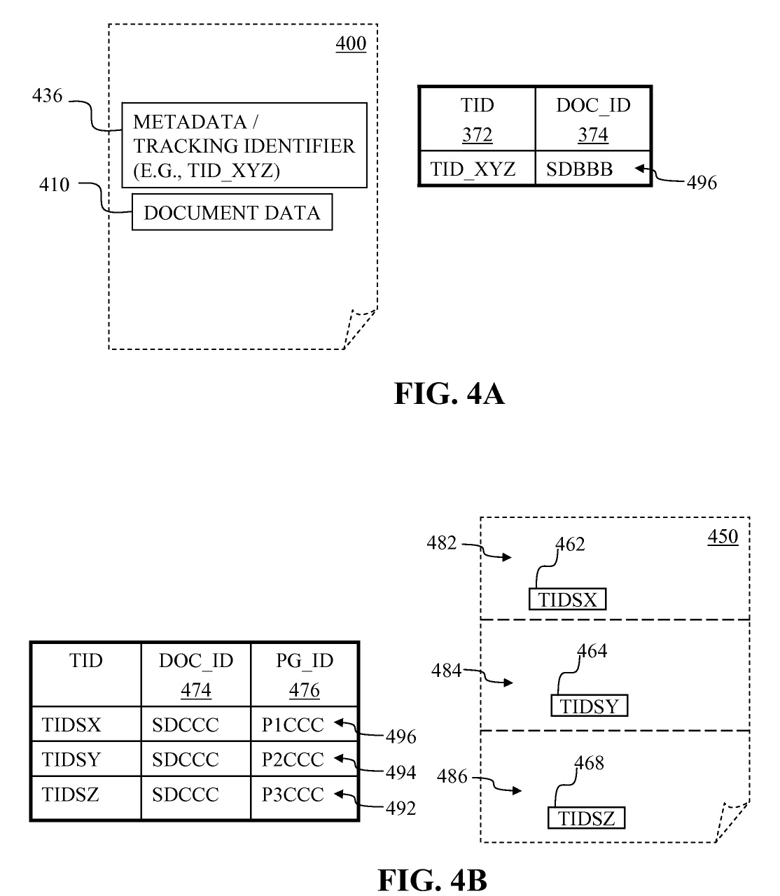

FIG. 4A is an exemplary softcopy 400, according to an embodiment of the invention. This exemplary softcopy 400 is an electronic file, which may reside in typically any computer-readable media, such as a hard drive, flash drive, thumb drive, and memory. This softcopy may also be represented as streaming data. This softcopy 400, as one of ordinary skill in the art will appreciate, may be copied to another file location, altered, emailed, archived, transferred and/or streamed to another location, and the like. An example of a softcopy, according to an embodiment of the invention, is a MICROSOFT WORD® document, which includes a tracking identifier 436 and document data 410. The tracking identifier 436 may be embodied and embedded within the document as a metadata or any representation of a tracking identifier, e.g., combination of characters to identify the document. In some embodiments, only one tracking identifier 436 is embedded within a softcopy document. The tracking identifier 436, e.g., TID_XYZ, associated with the exemplary softcopy document 400 may be stored or represented in a database, as an exemplary entry 496, thereby associating the tracking identifier 436, TID_XYZ, with the exemplary document 400, identified or associated with document ID “SDBBB.” In general, the tracking identifier is associated with the entire softcopy document. The entire softcopy document may be construed as a one-page only document. In some embodiments, however, where a softcopy 450 may be divided and its division logically recognized 482, 484, 486, for example, by pages, a tracking identifier may be incorporated or embedded associated with each division, e.g., per document page. In general, each tracking identifier is associated with a corresponding page or division of the softcopy document. The softcopy document may be construed as a multi-page document.

The tracking identifier may be embedded or embodied as metadata and placed, for example, in header sections, if appropriate, or where other metadata information may be stored. Typically the tracking identifier is placed in a softcopy in areas where the tracking identifier does not cause conflict or corrupt the softcopy or document data 410. Thus, in some embodiments, the placement of the tracking identifier is dependent on the file format. For example, the tracking identifier may be inserted in the header file of a Joint Photographic Experts Group (JPEG) document—e.g., file with a JPEG or JPG file extension. Thus, program instructions, e.g., software adapted to read or open the JPEG file, for example, is able to read the JPEG file with the embedded tracking identifier with potentially no degradation in data integrity, for example. The tracking identifier may be represented in a number of ways, e.g., string of alphanumeric characters, a numerical value, or string of alphanumeric characters and symbols.

In another example, a file/document with a tagged image file format (TIFF) may be associated with one or more tracking identifiers. A tracking identifier may identify or be associated with the entire document or a tracking identifier may identify or be associated with each division of the document. A TIFF document is an example where divisions in the softcopy document may be recognized or determined. Each page or image of a TIFF typically has an image file directory (IFD). Each IFD consists of a sequence of standard and proprietary tags or fields. A tracking identifier may be embedded as a metadata in a TIFF file by adding a private or special metadata tag or field in an IFD. For example, a tracking identifier associated with the entire TIFF file may be placed in the first image or IFD, or in all IFDs. In other embodiments, each IFD may contain a tracking identifier associated with the document and the page/image of that document, similar to the discussion in FIG. 3B, e.g., the first IFD in the TIFF document/file may contain a tracking identifier associated with a document ID associated with the TIFF document and a page ID associated with that page or image of that TIFF document.

In another example, each page or division 482, 484, 486 of a portable document format (PDF) document/file 450 has an object table. The divisions within a PDF document may be determined based on the object tables. Some objects in an object table are adapted to be printed while other objects represent other types of information. A special metadata object may be included in each object table, e.g., a different tracking identifier for each object table, thereby associating the tracking identifier with a corresponding document and PDF page number. In this example, the exemplary PDF has three pages 482, 484, 486 with each page associated with its own tracking identifier 462/482, 464/484, 468/486. Each tracking identifier 462/496, 464/494, 468/492 is associated with its corresponding document ID 474 and page ID 476, in this example.

One of ordinary skill in the art will appreciate that various file formats and/or file extensions typically have their own file structure and data storing means. For example, certain format types have unique signatures, such as character strings, that typically uniquely identify the format type. For example, a string “% PDF” in a header of an object/file typically indicates that the file is a PDF file. The file structures of most or all of the exemplary object/files below are defined by various standard groups and/or specifications and are typically available. Metadata sections may also be defined as part of the file structure. Table I below shows exemplary format types and their associated typically unique signatures, thereby identifying the particular file.

TABLE I
Exemplary Signatures Associated with Certain File Types

| Format Classification | | |
|---|---|---|
| Type | File Type | Signature |
| Formatted Document | PDF | % PDF |
| Formatted Document | RTF | {\rtf1\ansi |
| PDL Format | PJL | @PJL |
| PDL Format | PS | %!PS |
| PDL Format | PCL | <ESC>E |
| PDL Format | PCL XL | ) HP-PCL XL; |
| Image Format | TIFF | II*<NUL> or |
| | | MM<NUL>* |
| Image Format | JPEG | 0xFF 0xD8 0xFF 0xEE |
| Image Format | JPEG 2000 | 0xFF 0x4F |
| Image Format | PNG | 0x89PNG |
| Image Format | GIF | GIF87a OR |
| | | GIF89a |
| Image Format | MS Windows Bitmap | BM |
| Vector Format | SVG | <svg |

In other embodiments, the format type of a document may be determined by either the presence or absence of sequences. A file extension, for example, “.JPG” or “JPEG” may indicate a JPEG file, while a “.BMP” may indicate a MICROSOFT® WINDOW bitmap file. In other embodiments, the recurring presence of certain character constructions or strings, e.g., “<svg . . . >” may indicate an SVG file.

By identifying the document format type, the tracking identifier, including other relevant information, such as media storage/store ID, for example, may be stored and/or embedded in the softcopy, appropriately so as not to cause data integrity violation or data corruption. For example, the tracking identifier may be stored in the header section, metadata section, and/or comment section, depending on the document structure. In some embodiments, the tracking identifier and other relevant information are divided so as to be embedded in multiple areas. For example, a tracking identifier is divided so that the first part is stored in one section and the latter part is stored in another section of the document. In other embodiments, the tracking identifier is stored in one section, while other relevant information is stored in another section. Variations in the manner of embedding tracking identifier, including relevant information, may be varied and yet be within the scope of the present invention. In other embodiments, the tracking identifier is associated with a set of information, which may be stored in a database interfacing with the tracking server 110. For example, the tracking server may store the media store ID, authorized document/file manipulations—e.g., copy/replicate, delete, and move, and other document and control information associated with the tracking identifier.

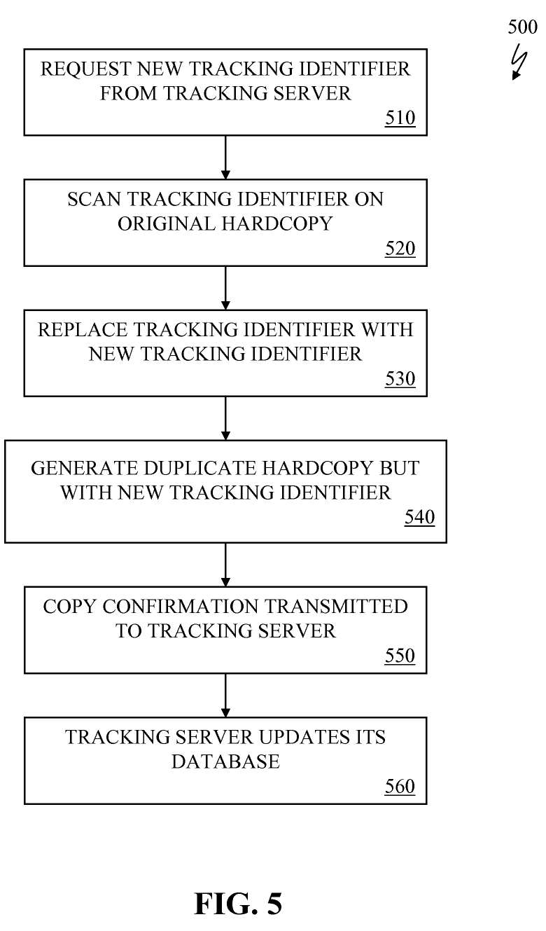

FIG. 5 is a top-level flowchart of an exemplary process 500 to track hardcopies, including the copies/replicas/duplicates of such hardcopies. A copy/duplicate/replica of an original document, however, is not an exact copy considering that a different tracking identifier is embedded in the copy document. This applies for both softcopy and hardcopy documents. In this example, a page of a hardcopy is to be copied/duplicated, which we call in this example, the original hardcopy. The reproducing device of the present invention, adapted to also function as a copier, requests for a new tracking identifier to be associated with the duplicate of the original hardcopy (step 510). The reproducing device also scans or detects for the tracking identifier associated with the original page to be duplicated (step 520), which may be printed on one or both surfaces of the original hardcopy page. As discussed above, the placement of such tracking identifier, including size and tracking identifier type—e.g., barcode, watermark or MICR, may depend on implementation. In some embodiments, the original hardcopy to be duplicated has been created by a non-tracking and control system, thus, the tracking identifier may be absent from that page, for example. The reproducing device accordingly replaces the scanned tracking identifier of the original hardcopy page, if any, with the new tracking identifier received from the tracking server (step 530). In general, the new tracking identifier provided by the tracking server is embedded, e.g., printed, on the duplicate hardcopy, i.e., the tracking identifier present on the original hardcopy page is replaced with the new tracking identifier. Thus, when the duplicate hardcopy is printed, a different and new barcode, for example, is printed, e.g., on the area where the tracking identifier of the original hardcopy page may have been. Generally, the duplicate hardcopy looks like the original hardcopy page, but with a different barcode, for example (step 540). If the original hardcopy page is not created by an exemplary tracking and control system, i.e., it has no tracking identifier, a surface area of the duplicate hardcopy is printed with the new tracking identifier provided by the tracking server (step 540).

For example, in embodiments where a tracking identifier is embedded as a barcode, the barcode or image scanning module 158 of a track and control copier 150, scans or reads the hardcopy page and determines, for example, interfacing with the processing module 153, the location of, size of, and the tracking identifier represented by that bar code. This bar code scanning and processing modules 153, 158 typically read the embedded bar code and determine the tracking identifier information contained or represented in that printed bar code. Once the location, size, and tracking identifier are determined, the processing module 163 of the printing subsystem 160 may then replace the area occupied by the read/scanned bar code by a new bar code representing the new tracking identifier provided by the tracking server, so that when the duplicate of the hardcopy is printed, the duplicate is printed with the new tracking identifier absent the tracking identifier of the original document.

In another example, where a tracking identifier is embedded as a watermark, an image scanning module 158 of a track and control copier 150, scans or reads the hardcopy page and determines, for example, interfacing with the processing module 153, the location of, size of, and the tracking identifier represented by the digital watermark. These image scanning and processing modules 153, 158 typically read the embedded watermark and determine the tracking identifier information contained or represented in that watermark. Once the location, size, and tracking identifier are determined, the processing module 163 of the printing subsystem 160 may then replace the area occupied by the read/scanned watermark by a new watermark representing the new tracking identifier provided by the tracking server, so that when the duplicate of the hardcopy is printed, the duplicate is printed with the new tracking identifier absent the tracking identifier of the original document. In other embodiments, the new watermark/tracking identifier may be printed in a different location. Furthermore, in other embodiments, the area occupied by the scanned watermark of the original document may be printed without the underlying watermark and the new watermark/tracking identifier printed in a different area. The watermarks of the present invention may be visible or invisible/hidden watermarks. In some embodiments, the document data of the original document and the replicated document may not be exactly the same, considering that some bits may be manipulated to include watermarks, for example.

In some embodiments, copy status information is also transmitted to the tracking server indicating that the copy process is successful or not (step 550). Such status information may be determined via physical sensors, e.g., paper jam sensors, software sensors, e.g., out of memory error in the firmware, or a combination or physical and software sensors. The tracking server accordingly updates its database 560 reflecting that a hardcopy document has been duplicated. In some embodiments, the tracking server automatically updates its database when the tracking server transmits the new tracking identifier to the reproducing device. This duplicated hardcopy is associated with the new tracking identifier provided by the tracking server.

In other embodiments, a printout or hardcopy as a result of printing a softcopy document may also be tracked. For example, the hardcopy based on a softcopy MICROSOFT WORD® document may be printed with a new tracking identifier associated with or embedded in the hardcopy document. Typically, the addition or embedding of the new tracking identifier on the hardcopy is performed by a track and control device, such as a printer, and not by the program application such as the exemplary MICROSOFT WORD® program. Typically, the track and control printer determines the location and size of the new tracking identifier to be printed. Once that is determined, the hardcopy output of that WORD document is printed with the embedded new tracking identifier. SHARP MX-2700N copier/printer, for example, supports adding barcodes and other images to a printed output.

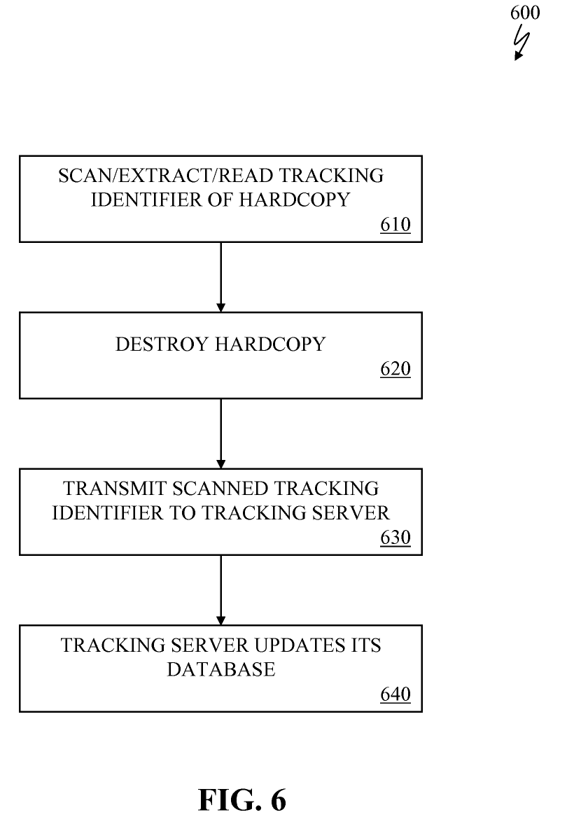

FIG. 6 is a top-level flowchart of an exemplary process 600 to track destroyed or to be destroyed hardcopy documents. If a user wishes to destroy a hardcopy document, the hardcopy is typically positioned, for example, by a user or via an automatic process such as using a document feeder, in such a way such that the surface of the hardcopy document may be scanned so as to detect the tracking identifier of the document to be destroyed (step 610). A hardcopy may be destroyed, for example, by shredding, burning, or any process that may mutilate or make the information on the hardcopy difficult to read or understand. After determining the tracking identifier, the hardcopy may be destroyed (step 620), e.g., by an automatic process or by having the user place the hardcopy document in a destruction module or apparatus means, e.g., shredder. In some embodiments, the destruction module may be separate from the module that interfaces with the tracking server. Once the document is destroyed, the device detecting the tracking identifier, transmits the scanned tracking identifier from the hardcopy document (step 630) so as to enable the tracking server to update its database and mark that the hardcopy has been destroyed (step 640). In some embodiments, the tracking identifier is transmitted immediately after the tracking identifier is scanned, whether the destruction of the hardcopy is successful or not. In other embodiments, in addition to the tracking identifier, an indicator informing that the tracking identifier is associated with a destruction process is sent to the tracking server.

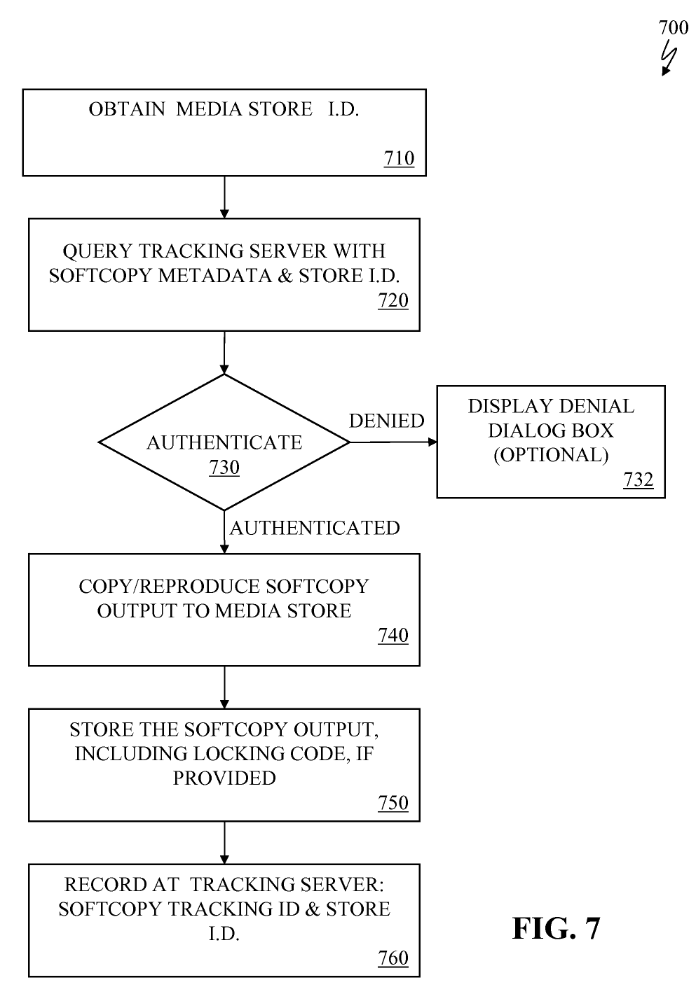

FIG. 7 illustrates a top-level exemplary flowchart 700 illustrating an exemplary tracking and control of a softcopy, for example, of copying, reproducing, duplicating, or replicating a softcopy input onto a media storage or data store. In general, the reproducing device typically first authenticates the media or data store to which the softcopy input is to be outputted or reproduced. The media/data store may be incorporated in systems with network file systems, file transfer protocol (FTP) directory systems, email systems, and/or data drives, which may include hard drives, CDs, thumb drives/memory sticks. In general, the media or data store identifier/ID, identifying the media or data store, is obtained or determined by the reproducing device, e.g., the reproducing devices 220, 230 in FIG. 2 (step 710). In some embodiments, the device interfacing with the media store may maintain a database identifying the media store ID of a particular media store. The media store ID may be based on a serial number unique to that media store or a special file/files or token(s) stored on the media store, for example.

For example, MICROSOFT® defines a device identification protocol, e.g., the universal plug and play protocol. When devices, e.g., thumb drives, are first connected, one of the operations of this protocol is the exchange of a unique ID stored in the device. In other embodiments, the storage device may contain a known file which contains the unique identifying information. In some embodiments, this identifying information may be protected by encryption and/or a digital signature.

This step (step 710) may include the reproducing device querying an internal look-up table to querying a relational database of a local or remote server. The tracking server 110 may then be queried based on the media store ID and/or the tracking ID of the softcopy input to be reproduced or copied to determine characterization of the content of the softcopy and/or scope of allowed or authorized reproducibility thereof (step 720). The tracking server may also conduct an authenticating comparison (step 730), thereby (a) issuing a denial communication (step 732) that may be displayed to the user in graphical screen imagery such as a dialog box or (b) issuing an authenticating communication to the reproducing device which permits or enables the reproducing device to reproduce the softcopy onto the target media store (step 740). This authenticating communication may include a new tracking ID for the softcopy output to be reproduced from the softcopy input or original.

Typically an authenticated media store is authorized to store any reproduced softcopies. Other manners of controlling documents may also be implemented, such as only specific media stores may be authorized to have particular reproduced softcopies stored onto them and/or a particular softcopy may only be reproduced and stored on one or more specific media stores. For example, only certain media stores, such as non-removable storage devices, may store certain softcopies. Thus, in some embodiments, the characteristics of the media storage device may be maintained in the tracking server and/or the reproducing device. Some characteristics that may be stored, for example, include whether the media store is removable and/or portable and whether it is a memory stick or not. In other exemplary embodiments, a very sensitive softcopy document may be identified by its tracking ID and may be only reproduced or copied to specific media store(s). Other variations in the manner of document control may also be implemented.

Assuming that the media/data store is authenticated so as to be authorized to have a copy of the softcopy input, the reproducing device reproduces/copies/replicates the softcopy input onto the media store as a softcopy output—i.e., a copy of the softcopy input. The softcopy output typically has a tracking ID unique and/or different from the tracking ID of the softcopy input. In some embodiments, the tracking server also provides a locking code to the reproducing device, which is also stored in the media store. This locking code may be embedded within the softcopy output or may be placed in a file separate from the softcopy output. A locking code may be part of the softcopy metadata and both the locking code and softcopy output may be stored to the target media store (step 750). A locking code, for example, may be provided if the softcopy is to be stored on a removable media store, such as a thumb drive, and generally ensures that a softcopy stored in the removable media store is not deleted without proper authorization. If the tracking server has not already done so, the tracking server may relate or otherwise record, for example, in a database, the tracking ID of the softcopy output and/or the media store ID (step 760). In some embodiments, historical or transactional information related to a softcopy is also stored, which may include date, time, and operation(s) performed, e.g., copied, deleted, and moved. In some embodiments, a history of a softcopy may be maintained and determined, so as to enable determination, for example, of the number of times a softcopy was copied, when such copies/replicas of the softcopies were made, whether the replicas themselves were copied and/or deleted, and where such softcopies, including replicas, are stored. The granularity or the amount of information stored in a database interfacing with the tracking server may depend on the historical information, security detail, or control information the tracking and control system is adapted to monitor and maintain. In other embodiments, identifying characteristics of the reproducing or destructing devices which are adapted to perform the operation may also be maintained. Such identifying characteristics may include whether the device is a copier, printer, shredder, part of which network, device ID, etc.

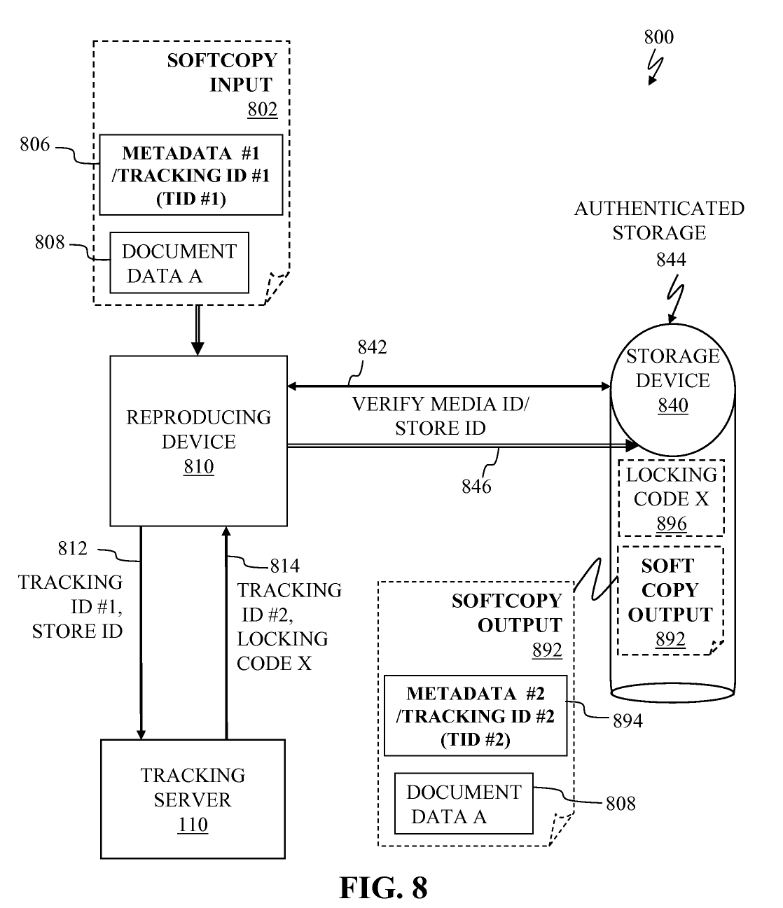

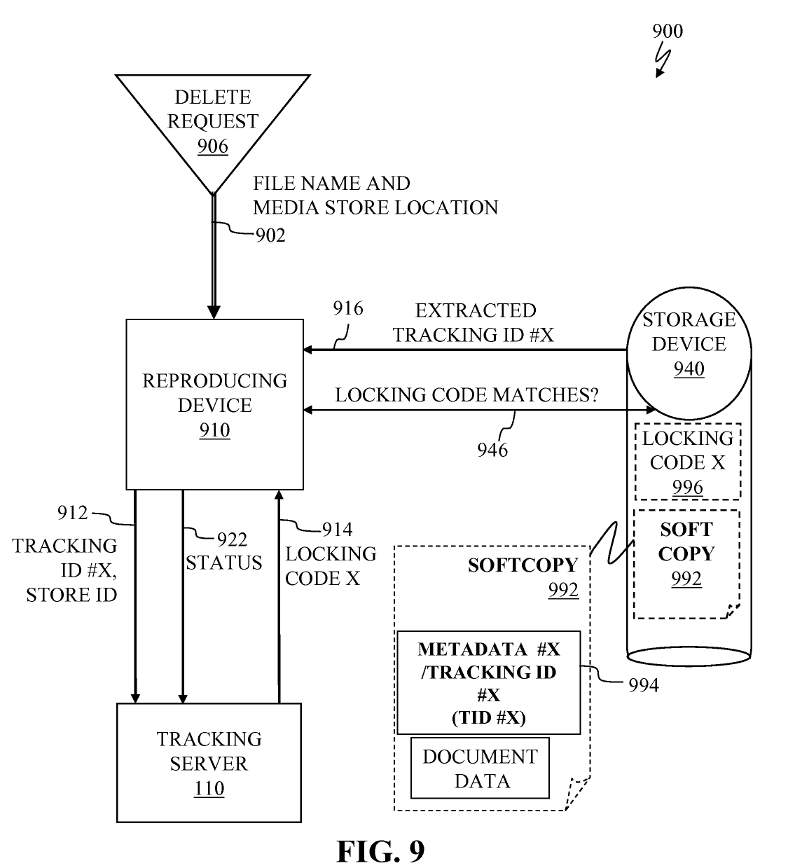

FIG. 8 is a high-level exemplary data flow 800 illustrating a manner in which a softcopy input is replicated or copied into a media storage 840. The softcopy input 802, embodied as an electronic file, includes a tracking identifier 806—TID #1 and document data A 808. The reproducing device 810, for example, a computer instructed to replicate the softcopy input 802 into a remote hard drive 840, first verifies or determines the media store ID 840—typically uniquely identifying that media store—of that hard drive. Once this media store ID is determined 842, the reproducing device 810 communicates 812 the tracking identifier, TID #1, of the softcopy input 802 and/or the media store ID of the hard drive 840. The tracking server 110, based on the document control and tracking conditions implemented, may accordingly send a new tracking identifier 814, e.g., TID #2, to the reproducing device. The authentication of the media store 840 may be performed at the reproducing device 810, at the tracking server 110, or both. This new tracking identifier 814, e.g., Tracking ID #2 (TID #2), may be part of an authorizing communication indicating to the reproducing device 810 that it is authorized to replicate the softcopy input 802 onto the storage device 840. The reproducing device 810 replicates 846 the softcopy input 802 as a softcopy output 892, with the same document data A 808 but with a different tracking identifier 894, i.e., TID #2—which is the tracking identifier 814 provided by the tracking server 110. This process may entail, for example, parsing the softcopy input 802 and removing the TID #1, e.g., represented as metadata, from the file and replacing that TID #1 with TID #2, prior to storing 846 the softcopy output 892 onto the authenticated media store 844, 840. The tracking server typically updates its database, indicating that the document 802 identified with TID #1 has been copied to another document 892 with TID #2 and is stored at the media store 840.

In some embodiments, if the media store adapted to receive the replicated document is a removable storage device or based on other conditions, the tracking server may also include as part of its authentication a locking code or ID 814, which in some embodiments, prevents the deletion and/or copying of a softcopy without having the reproducing device be provided with the appropriate locking code. Although a reproducing device herein is called a “reproducing” device, the reproducing devices of the present invention may also be adapted to delete softcopies, such as computers are adapted to not only copy files onto media storage, but delete files or softcopies, as well.

This locking code transmitted to the reproducing device, e.g., locking code X 814, is also stored 896 in the media store 840, associated with the appropriate softcopies. In this example, the softcopy 892 identified with TID #2 894 is associated with locking code X 896. The locking code 896 may be stored in a file separate from the softcopy or may also be embedded within the softcopy, e.g., as a metadata in a file. In some embodiments, the locking code may be stored in encrypted form. The locking code/key feature may be implemented as an optional feature. In some embodiments, the tracking identifier and the locking code may be contained in the same metadata location, e.g., same IFD, same header section, same object table, and the like.

### Softcopy Destruction and Exemplary Monitoring Processes

In some embodiments, the method for the destruction, such as deletion, of a softcopy is controlled by the type of media storage. If the media storage is part of a secured file system, the secured file system first extracts the tracking identifier, which may be embodied as metadata, from the softcopy. The tracking device of this secured file system may then monitor the success of the deletion request and send a notification to the tracking server of the successful or failed destruction or deletion of the intended softcopy. Such notification may include for example, the tracking identifier of the softcopy instructed to be deleted, identifying characteristics of the processing device performing the destruction and a flag indicating success or failure of the deletion request. In general a secured file system is a file system that performs additional file-related operations, relating to security. One such file-related security operation is to maintain an audit log on every file operation performed on a file, thus, a secured file system may record the deletion as while as the creation of a file.

In embodiments where a softcopy may be outputted or copied to a non-secure file system, a monitoring process may be executed on the file system that monitors for the presence or absence of softcopies. This monitoring process may be executed on demand, periodically, or based on other conditions. This monitoring process may be performed by the reproducing devices, the tracking server, other processing unit(s) within the exemplary tracking and control system 100, or combinations thereof. In general, the monitoring process performs a complete or partial sweep of typically each media storage authenticated or which the monitoring process has access to, in the exemplary tracking and control system. This monitoring process typically includes detecting or determining which softcopies are stored in the media store based on tracking identifiers. Tracking identifiers of detected softcopies are stored by the monitoring process and may optionally be transmitted to the tracking server, if appropriate. In the next cycle, the monitoring process again determines the softcopies stored in the media store based on tracking identifiers. A comparison is then made between the previous detected tracking identifiers and the detected tracking identifiers of the current cycle. The softcopies associated with the tracking identifiers detected in the previous monitoring process cycle, but not detected in the current monitoring process cycle are deemed or flagged as successfully deleted or destroyed. These undetected tracking identifiers in the current processing cycle are then provided to the tracking server to enable the tracking server to update its database accordingly. In some embodiments, the results of each monitoring cycle are provided to the tracking server, and the tracking server compares its database versus the results of the monitoring cycle and accordingly updates its database.

FIG. 9 is a high-level data flow diagram 900 of an exemplary locking feature of the present invention. In general, if a softcopy, e.g., an electronic file, is stored on removable media, the tracking and control system may implement a locking mechanism that prevents the deletion of a softcopy or file unless a deletion locking code is provided. When the softcopy is first stored onto the removable storage medium 840, the tracking server may provide the reproducing device with a locking code. The reproducing device passes the locking code as part of the file copy to the removable media. The removable device then locks the softcopy on the storage medium using the corresponding or associated locking code (key).

To destroy a softcopy 992 that has an associated locking code 996, a user typically inserts, e.g., via a Universal Serial Bus (USB) port, the removable media 940 into a reproducing device 910 that is adapted to perform the locking code processing of the present invention. For example, the reproducing device 910 may be a personal computer having an operating system supporting file deletion or the device may be some other electronic file reproducing and destroying device. Typically, a delete request 906 includes the file name and the location where the file is located 902. This delete request, for example, may have been manually entered by a user via a command line interface, via a windows application program and pressing the delete key, or may have been requested by an application program, e.g., via a batch job. For example, after having the file information on the softcopy deleted 992, the reproducing device, now performing its deletion or destruction functions, extracts the tracking identifier 994—e.g., tracking ID #X—from the metadata of the softcopy 992. This tracking identifier, tracking ID #X, and, optionally, including the store ID of the storage device 940 are transmitted 912 to the tracking server 110. The tracking server 110 accesses its database to determine the locking code, e.g. locking code X 914, associated with the softcopy to be deleted. In some embodiments, the store ID was also previously stored, when the softcopy was initially copied onto the storage medium. Thus, a storage ID and tracking identifier association may have been previously stored in a database accessible by the tracking server. By having the tracking identifier, the tracking server is already aware of the store ID and tracking identifier association. The locking code 914 is transmitted or passed to the reproducing device 910. Using the locking code passed by the tracking server 914, the reproducing device 910 verifies if the locking code 996 stored in the storage device 996 matches 946 the locking code 914 transmitted by the tracking server 110. If the locking codes match 914, 996, the reproducing device accordingly deletes the softcopy 992. In some embodiments, the locking code is part of the metadata 994, thus as part of extracting the tracking identifier, the reproducing device also accordingly extracts the locking code from the metadata. In other embodiments, the locking code is part of a locking code database, e.g., in a hidden and/or encrypted file, stored in the storage device 940, such that this locking code database contains locking codes and their associated tracking identifiers. The reproducing device 910 thus reads this locking code database to determine the locking code, if any, is associated with the softcopy to be deleted.

In some embodiments of the invention, once the tracking server 110 passes the associated locking code 914, the tracking server 110 accordingly updates its database indicating that the softcopy is deleted. In some embodiments, the reproducing device 910, when passing the tracking identifier and/or the store ID 912 to the tracking server, also passes information, e.g., flags, indicating that a delete request has been received by the reproducing device, thereby indicating to the tracking server that the request for locking code is in response to a delete request. In some embodiments, the reproducing device 910 sends status information 922, e.g., tracking identifier and success/failure flag, to the tracking server 110, indicating the success or failure of the deletion of the softcopy prior to the tracking server 110 updating its database. In some embodiments, the reproducing device 910 sends reproducing device identifying characteristics—e.g., Internet Protocol (IP) address and domain name system (DNS) name, operating ID, serial number, and model and options information—to the tracking server 110.

One of ordinary skill in the art will appreciate that the manner and/or timing of updating the databases may be varied and yet still be in the scope of the present invention. The destruction process may be any deletion process known to those of ordinary skill in the art, for example, deleting entries in a file allocation table or any file directory structure table. Furthermore, the destruction process may be performed in many ways, e.g., a program application running in a removable drive may perform the deletion process, or a hosting device, e.g., a PDA, operably connected to the reproducing device may perform the deletion operation.

### Move or Transfer of Softcopy Documents

The embodiments of the present invention may also control and track documents that have been moved or transferred, for example, from one file location, e.g., location A, to another, e.g., location B. In some embodiments, the tracking identifier of the document is reused, such that the tracking identifier embedded in the document when that document is in location A is the same tracking identifier embedded in the document when that document is stored in location B. The tracking information contained in the exemplary database 112 may contain a history of such operations, thereby indicating that the document was moved from location A to location B.

In other embodiments, a transfer or move of a softcopy document results in a new tracking identifier assigned to the document when moved from location A to location B. Tracking information linking the document from its previous location A to its new location, location B, may be kept so as to be able to associate the old tracking identifier in location A to the new tracking identifier in location B. Information indicating that the document has been moved may also be maintained or recorded.

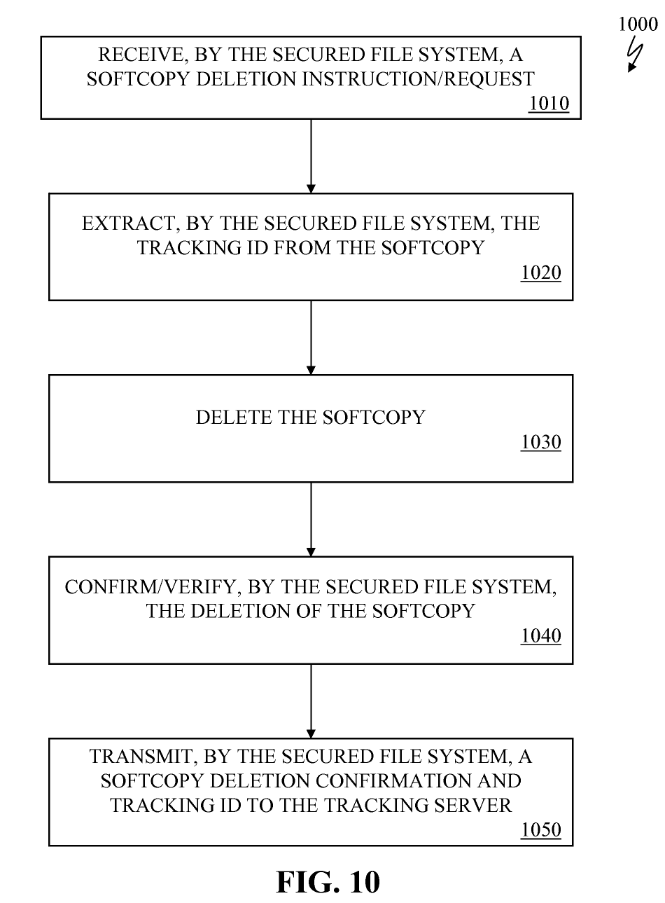

FIG. 10 illustrates in a top-level flowchart an exemplary process 1000 for securely destroying, particularly deleting, and tracking the deletion of a softcopy, according to an embodiment of the invention. This exemplary process may be implemented where a locking code is not applied. FIG. 10 is discussed in conjunction with FIG. 9. In this example, a secured file system receives a softcopy deletion instruction 906, e.g., from a user (step 1010). The secured file system may then extract the tracking identifier 994 from the softcopy 916 (step 1020). The secured file system may then delete the softcopy (step 1030) which is a process that, depending on the media, may include successive block or random writings over the memory addressed most recently populated last by the deleted softcopy and/or updating entries in file allocation table(s). The file system or a monitor module in the file system may conduct a file search or execute other files or partial files testing sub-steps to confirm the deletion of the softcopy (step 1040). Once the deletion has been confirmed by the file system, a deletion confirmation including a softcopy tracking identifier 916, 922 may be transmitted to the tracking server (step 1050). In some embodiments, the tracking identifier is transmitted to the tracking server even without confirmation of the successful deletion of the softcopy. In some embodiments, once the tracking server receives the tracking identifier of the softcopy requested to be deleted, the tracking server typically updates its database. This exemplary process 1000 may also be applied to non-secured file systems.

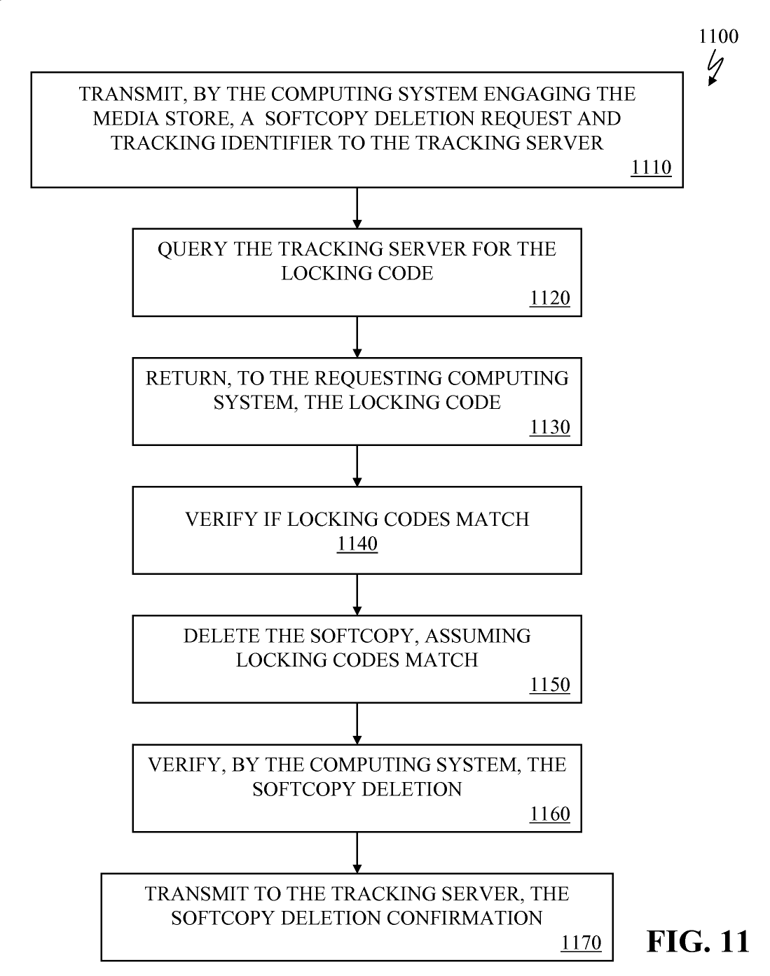

FIG. 11 illustrates in a top-level flowchart an exemplary process 1100 for deleting a softcopy in, for example, an unsecured file system or removable media storage device. In this example, the reproducing device, e.g., a computing system, may engage a media storage device or a media store and transmit a softcopy deletion request and tracking identifier to the tracking server (step 1110). The tracking server may then be queried for the locking code (step 1120). The tracking server may then return to the requesting computing system the requested locking code (step 1130). The computing system may then verify if the locking code transmitted by the tracking server matches the locking code stored and associated with the tracking identifier of the softcopy (step 1140). Upon receipt of the locking code and verification that the locking codes match, the computing system may then delete the softcopy (step 1150). The computing system may then conduct a verifying operation to assure the successful deletion of the softcopy (step 1160). The verification operation may include in the short term writing over the memory locations of the softcopy and/or a high level file scan and may also include low-level scanning or monitoring of files for the deleted tracking code or the presence or absence of the softcopy within the designated media store. Typically after a short-term validation of the softcopy deletion, the computing system may transmit to the tracking server the softcopy deletion confirmation (step 1170). In some embodiments, e.g., wherein there is a locking code database, which may be resident in the reproducing device and/or the storage device, the locking code database may accordingly be updated, such as removing the tracking identifier with its associated locking code, for example.

### Monitoring Process

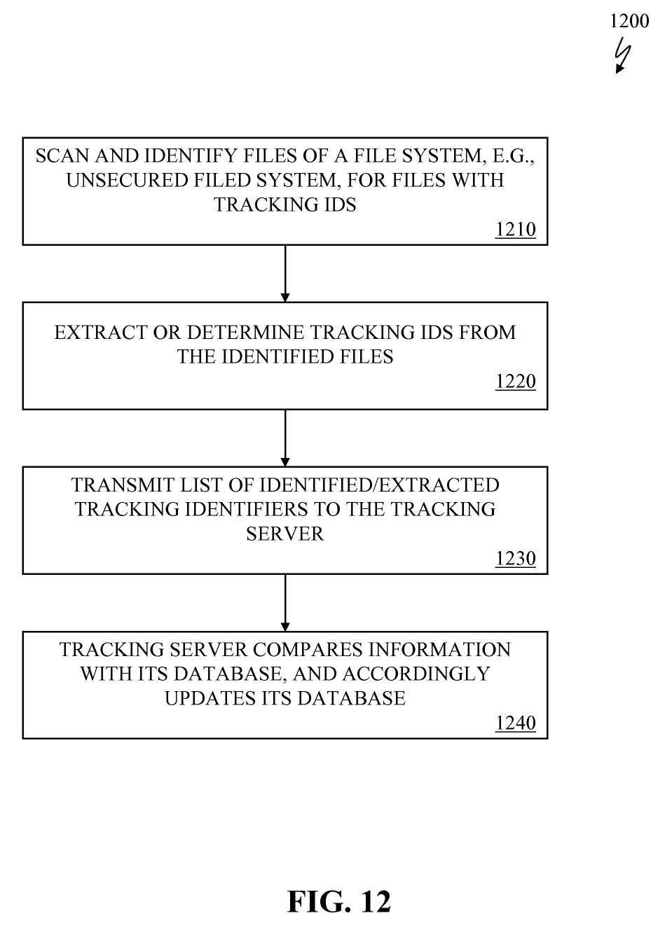

FIG. 12 illustrates in a top-level flowchart an exemplary process 1200 for monitoring the presence of files having tracking identifiers in a file system, particularly in an unsecured file system. The files of a file system may be scanned and tested for those files identified as having a tracking identifier (step 1210). The tracking identifier of each identified file may be extracted (step 1220). A list of identified tracking identifiers may then be transmitted to the tracking server to verify that information contained in the database maintained by the tracking server is current or is consistent with what has been determined by the monitoring process (step 1230). Once received, the tracking server accordingly updates its database (step 1240), e.g., adding tracking identifiers not previously recorded as copied, deleting tracking identifiers that are not found by the monitoring process—but are in the database maintained by the tracking server, marking a tracking identifier as available when it was previously marked deleted, and updating location—e.g., media store ID—of associated tracking identifiers. In general, the monitoring process may be performed to determine, whether a particular softcopy or a set of softcopies, has been deleted, copied, and or moved. In other embodiments, the monitoring process may be performed to do a complete or partial scan of the file system, so as to provide information to the tracking server of tracking identifiers actually residing in media stores. The monitoring process may also be adapted to search for a particular set of softcopies. Various other means of monitoring processes are known to those skilled in the art. For example, a scanning or search module may automatically search or scan the file system of a mobile device whenever the scanning/search module and the mobile device are in wireless proximity of each other.

### Softcopy Encryption

In another embodiment of the present invention, a softcopy output may be further secured by encrypting the softcopy data. For example, if a reproduced softcopy is replicated/copied outside of the secure tracking and control system 100, 200, the replicated softcopy is not readily usable unless decrypted. Generally, the tracking server of this exemplary embodiment may apply an encryption algorithm, e.g., the tracking server may advertise its public key to the document reproduction system/device, and the document reproduction system/device may then use the public key in executing the steps of an algorithm to encrypt the softcopy output. The softcopy output is thus stored in encrypted form. Other encryption technologies, e.g., a single key encryption scheme, may also be applied.

There are two basic types of cryptography/encryption: secret key or symmetric cryptography and public key or asymmetric cryptography. These keys are generally represented as numbers. In secret key cryptography, one key is shared by two or more parties or stations. To encrypt a message, a mathematical function or algorithm is applied that takes the message and the key as inputs thereby generating an encrypted message. The reverse operation, decryption, also requires the use of the same key. Thus, stations that have the same secret key may encrypt and decrypt, i.e., read, the same messages, while those that do not have the same key cannot.

Public key cryptography, on the other hand, uses a pair of keys—a public key and a private key. Encryption of a message is done using the public key, while decryption is done using the private key. Thus, anyone with the public key can encrypt a message, but only the person who has the private key can decrypt and read the message. The private and public keys are mathematically related, but the mathematical techniques are such that knowledge of one of the keys does not enable a person to calculate the other key. There are various encryption algorithms, standards, and architectures currently available—for example, Data Encryption Standard (DES) by IBM (TM). Rivest Cipher version 4 (RC4), Rijndael, and Advanced Encryption Standard (AES) adopted by the U.S. government in 2000. Various cryptographic and encryption techniques are known to those of ordinary skill in the art.

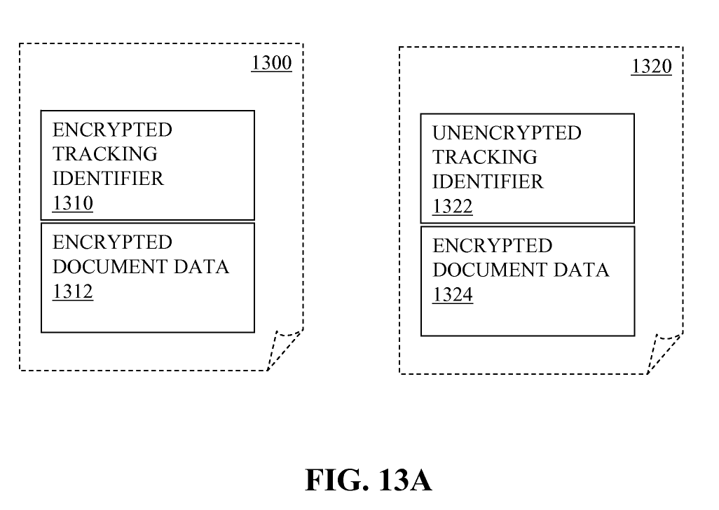

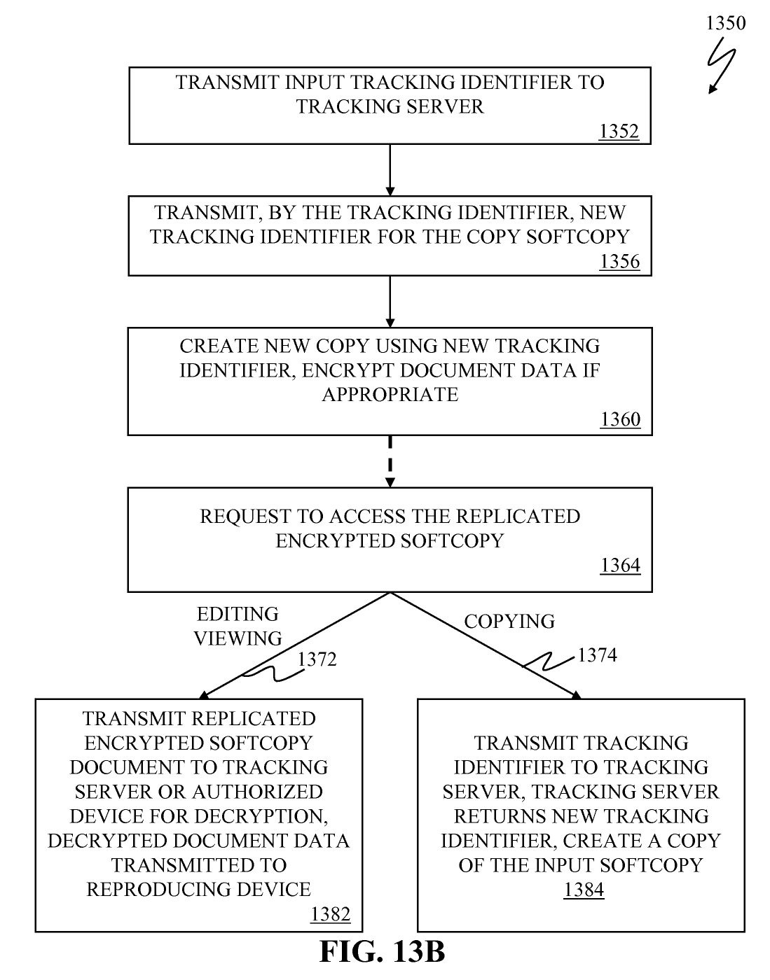

FIG. 13A is a block diagram of exemplary encrypted softcopy documents 1300, 1320, according to embodiments of the present invention. In general, a softcopy includes two parts-a tracking identifier 1310, 1322 within a tracking identifier area and the document data 1312, 1324 in a document data area. In some embodiments, the tracking identifier is placed in a defined tracking identifier area or location, with a fixed size, within the softcopy document, while the document data is stored in a document data area starting from a defined location. For example, the tracking identifier may be stored as a header section starting from the first byte to the nth byte of the document, while the document data may start from the n+1th byte to the end of the document. By having the tracking identifier defined and stored in this manner, separate from the document data and in a defined location or area, a tracking identifier embedded in a softcopy may be quickly extracted to transmit to the tracking identifier, for example. The tracking identifier may be stored in the softcopy in encrypted 1310 or unencrypted form 1322. Typically, to provide security, the document data 1312, 1324 is encrypted.

When a softcopy is copied, in some embodiments, it may entail merely replacing the old or original tracking with the new tracking identifier. For example, a copy of an input encrypted softcopy document may be created by having the new tracking identifier be combined, e.g., concatenated, with the already encrypted document data. For example, if the encrypted document data starts from n+1 byte, the reproducing device typically just replaces the old tracking identifier with the new tracking identifier, by replacing the first byte to the nth byte with the new tracking identifier information. The encrypted document data residing in the n+1th byte to the end byte is just merely copied and concatenated to these first n bytes. Thus, in some embodiments, the document data need not be encrypted again, if it is already in encrypted form.

In some embodiments, the tracking identifier and the document data are encrypted with the same encryption key. In other embodiments, the tracking identifier is encrypted with an encryption key different from the encryption key used to encrypt the document data.

In some embodiments, not shown, the tracking identifier may be stored embedded within the document data of an encrypted softcopy document. In this exemplary embodiment, the entire encrypted softcopy document may be transmitted to the tracking server for decryption, so as to enable the tracking identifier to determine the tracking number of that encrypted softcopy document.

FIG. 13B illustrates in a top-level flowchart an exemplary process 1350 for reproducing a softcopy so as to generate an encrypted duplicate softcopy, using a public and private key pair. Typically, the reproducing device or secure file system receives, from the tracking server, a public encryption key that is typically advertised by the tracking server. To copy a softcopy document, the reproducing device first transmits to the tracking server the tracking identifier of the document to be copied (step 1352). The tracking server, in response to a request to make a copy, may also provide a new tracking identifier, encrypted or unencrypted, for the encrypted softcopy to be copied/generated (step 1356). In some embodiments, the tracking server updates its database to reflect that the file associated with the new tracking identifier is an encrypted file or is to be encrypted. The secure file system or reproducing device may then generate a replicated softcopy embedded with the new tracking identifier provided by the tracking server (step 1360). If the document data is not encrypted, the reproducing device encrypts the document data with the advertised public key (step 1360). In some embodiments, the replicated encrypted softcopy, when stored, has the tracking identifier separate from the document data as discussed in FIG. 13A, for example. In other embodiments, the tracking identifier may be embedded with the document data.

In this exemplary embodiment, let us assume that the tracking identifier is stored in a separate data space from the document data as discussed in FIG. 13A. A request to access this replicated encrypted softcopy may be received by the reproducing device (step 1364). This access request may be related to editing, viewing, copying, and other file operations or manipulations that may be performed. In some embodiments, if the document data has to be decrypted for appropriate file manipulation, for example, editing or viewing 1372, the reproducing device transmits the replicated encrypted softcopy document to the tracking server or to an authorized decryption device for decryption using the appropriate private key (step 1382). The appropriate device accordingly transmits the decrypted softcopy to the reproducing device so as to enable the appropriate file operations (step 1382). On the other hand, if decryption of the document data is not required, for example, for a copy operation 1374, the reproducing device typically transmits the tracking identifier of the replicated encrypted softcopy to the tracking server (step 1384). The reproducing device typically decrypts the tracking identifier, if encrypted, so as to update its database. A new tracking identifier is also generated by the tracking server which is also sent to the reproducing device (step 1384). The association between the received tracking identifier and the new tracking identifier generated—i.e., the document associated with the received tracking identifier is copied, and such copied document is associated with the new tracking identifier—is then stored accordingly in the database. Once the reproducing device receives the new tracking identifier, it generally concatenates or combines the new tracking identifier, assuming it is in a proper format or size, with the encrypted document data, so as to generate a copy of that document (step 1384). If the document data is not in encrypted form, the reproducing device may encrypt the document data using the advertised public key of the tracking server. The new tracking identifier is then concatenated with the encrypted document data so as to generate a replicated encrypted document. If the tracking identifier is not in appropriate format, e.g., not the defined size to fit the defined data space, formatting of the tracking identifier may be performed.

In some embodiments, the tracking server may also receive confirmation indicating the success or failure of the copy and/or encryption process. This confirmation may be used by the tracking server to update its database. In some embodiments, the tracking server keeps track of documents which are encrypted and the encryption keys associated with the tracking identifiers, if appropriate.

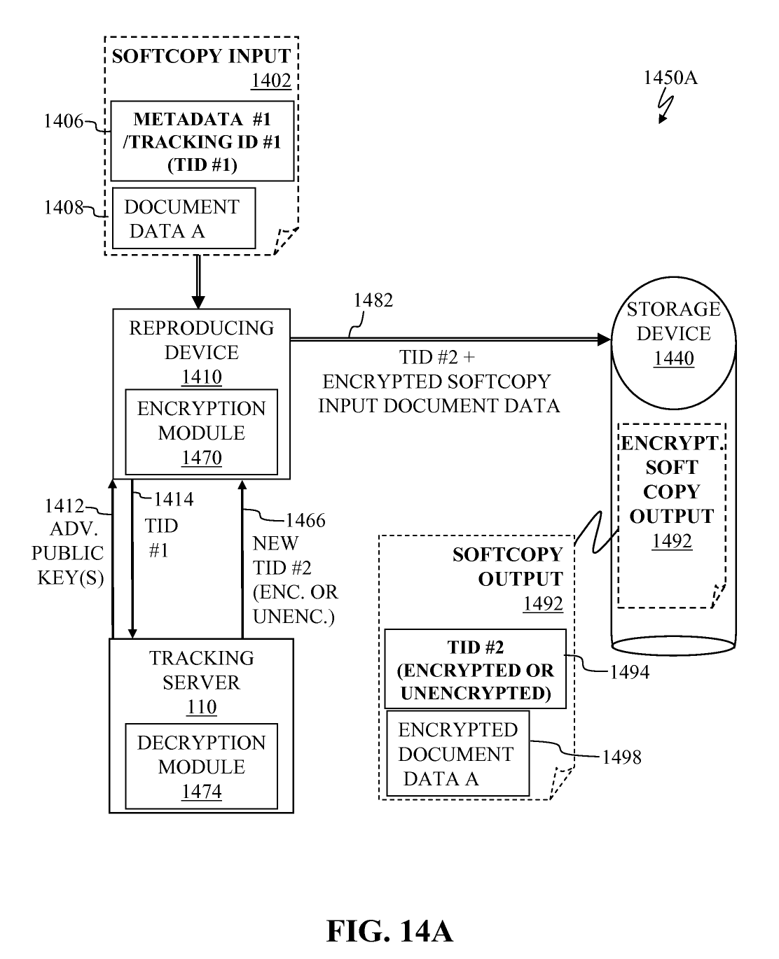

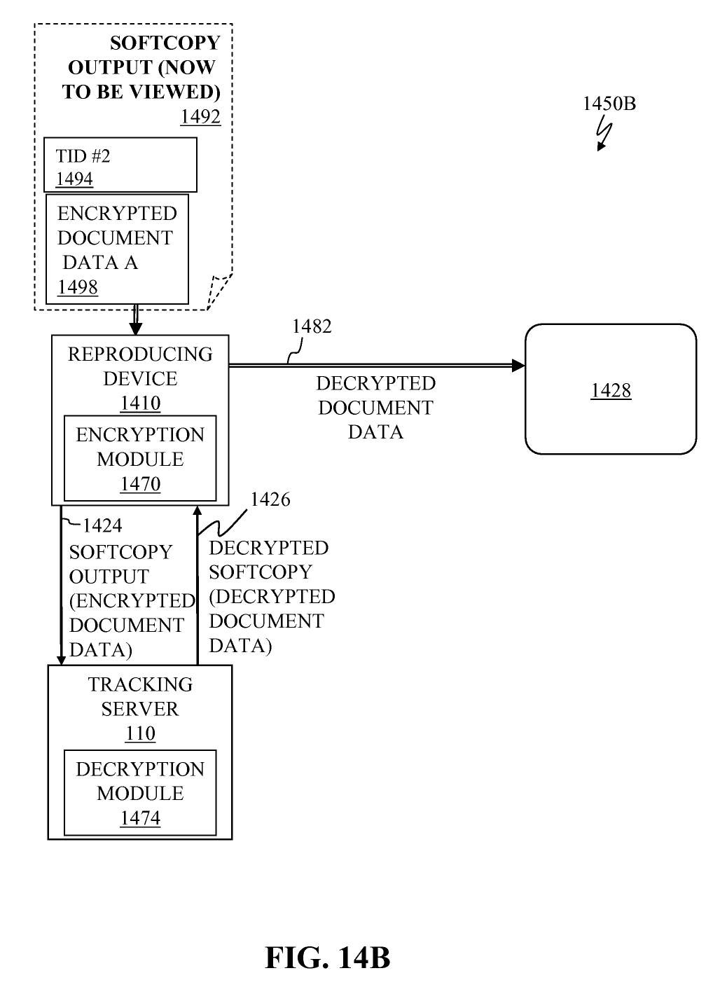

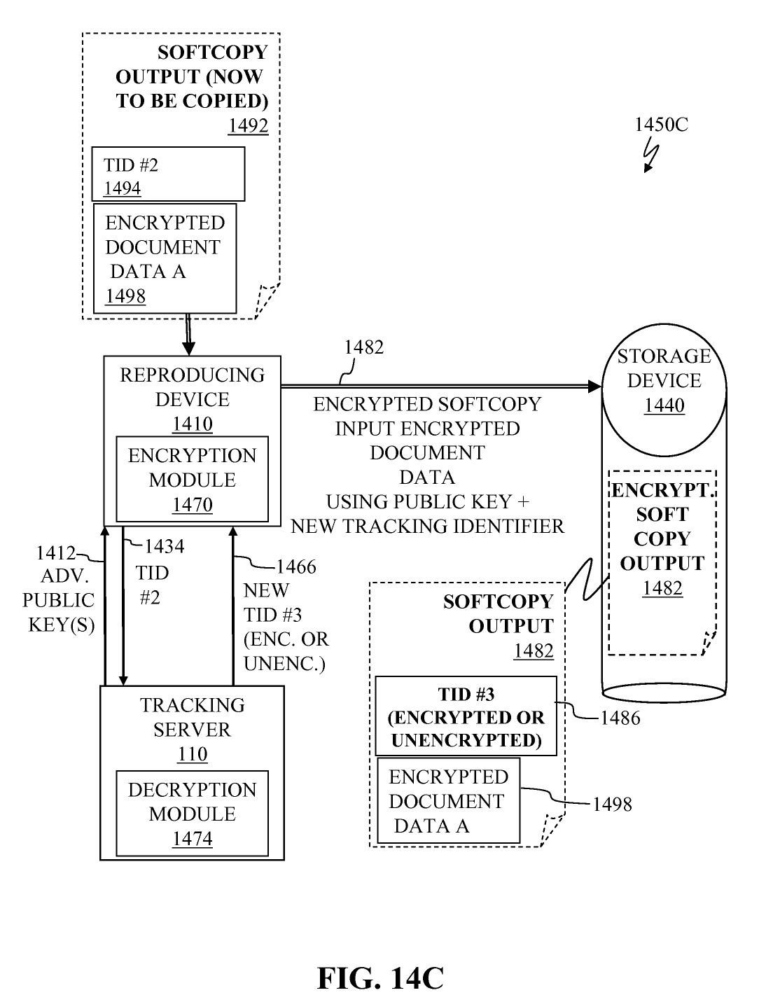

FIG. 14A is a diagram of an exemplary data flow 1450A illustrating data being exchanged when an unencrypted softcopy document is to be copied, and the copy is to be stored in encrypted form, according to an embodiment of the invention. The encrypted softcopy has the tracking identifier in a tracking identifier area separate from the document data in a document data area (see FIG. 13A). The input unencrypted softcopy 1402, embodied as an electronic file, includes a tracking identifier 1406—TID #1 and document data A 1408. The tracking identifier 1406 associated with this exemplary softcopy input 1402 may be embedded within the document data A 1408 or may be separate from the document data area. The tracking server 110 of the present invention typically advertises its public key 1412. Prior to copying or replicating the softcopy input 1402 in encrypted form, the reproducing device 1410 transmits the tracking identifier 1414, TID #1, of the softcopy input that is to be copied. In response to this request to copy the document, the tracking server 110 transmits a new tracking identifier 1466, e.g., TID #2, which is associated with the encrypted softcopy output 1492. The tracking server may accordingly update its database associating tracking identifier 1406, 1414, TID #1, to a document that is copied and such copy of that document is associated with a document identified with the new tracking identifier 1466, 1494, TID #2. The new tracking identifier 1466, TID #2, may be in encrypted or unencrypted form. Once the reproducing device receives the new tracking identifier 1466, the reproducing device 1410 using its encryption module 1470 accordingly encrypts the document data 1408, typically using the advertised public key 1412. The tracking identifier may be encrypted or not, depending on design implementation. The tracking identifier is packaged or formatted such that it is placed in the appropriate tracking identifier area and in the appropriate format, based on design implementation. The encrypted document data based on the input document data A 1408 is thus combined with the new tracking identifier so as to produce an encrypted copy of the softcopy input, i.e., the encrypted softcopy output 1492, which is stored in the appropriate data store 1440. The encrypted softcopy output is in the appropriate two-part format of an encrypted softcopy document as discussed above.

Let us assume that the reproducing device receives a request to view the encrypted softcopy output 1492. FIG. 14B is a diagram of an exemplary data flow 1450B between the reproducing device 1410 and the tracking server 110 to perform this viewing operation, according to an embodiment of the invention. In a viewing or editing operation, or in any other operation that may need the document data to be decrypted for proper file operation, the reproducing device 1410 transmits 1424 the encrypted softcopy 1492 for decryption by the tracking server or the appropriate device. In some embodiments, only the document data 1498, without the tracking identifier 1494, is transmitted. Using a decryption module 1474, the document data 1498 of the softcopy transmitted 1492 is decrypted. The tracking identifier may need not be decrypted if the tracking server does not keep track of viewing operations. The decrypted document data 1426, optionally including the tracking identifier, is then transmitted to the reproducing device 1410, for example for viewing 1482 in a display device 1428, for example.

Let us assume that from FIG. 14A, a request to copy, instead of viewing, is received by the reproducing device. FIG. 14C is a diagram of an exemplary data flow 1450C between the reproducing device 1410 and the tracking server 110 to perform a copy operation, according to an embodiment of the invention. To perform the copy operation, the reproducing device transmits the tracking identifier 1434, 1494 of the softcopy to be copied. In response to this copy request, the tracking server 110 transmits a new tracking identifier 1466, TID #3, which may be encrypted or unencrypted, to the reproducing device 1410. The reproducing device 1410 then, using the new tracking identifier 1466, concatenates the new tracking identifier received 1466 with the already encrypted document data A 1498, to generate a copy 1482 of the softcopy document 1492. The new tracking identifier is embedded in the softcopy within the appropriate tracking identifier area, while the encrypted document data occupies the document data area. This copy document 1482 is stored in the storage device 1440, and thus includes TID #3 1486 and the same encrypted document data 1498.

The embodiments of the present invention may also apply when symmetric encryption, i.e., only one encryption key for encryption and decryption, is employed. In these embodiments, the tracking server may optionally transmit the symmetric key to the reproducing device to appropriately encrypt and decrypt the softcopy input. One of ordinary skill in the art will appreciate that the exemplary encryption processes described above may be varied and yet still be in the scope of the present invention. For example, considering that the reproducing device may already be in possession of the encryption key to decrypt the document data, the reproducing device may not need to transmit the document data to the tracking server for decryption. The reproducing device may directly decrypt the softcopy document, particularly document data, for data viewing, for example. In some embodiments, there may be a key for the tracking identifier and another for the document data.

The exemplary database 112 of the present invention may contain various information associated with the tracking identifier. The tracking identifier, for example, may be associated with document-identifying characteristics—such as original document/file name, document/file size, and thumbnail or preview image, date and time of operations—e.g., when replicated and when destroyed, the identifying characteristics of the processing device, for example, device identification, type of device—e.g., printer or copier, that performed the operation, the number of times a document was copied, etc.

Although this invention has been disclosed in the context of certain embodiments and examples, it will be understood by those of ordinary skill in the art that the present invention extends beyond the specifically disclosed embodiments to other alternative embodiments and/or uses of the invention and obvious modifications and equivalents thereof. For example, although the embodiments of the invention are exemplified using public and private key pairs, the embodiments of the invention may also apply to single symmetric key encryption/decryption. In addition, while a number of variations of the invention have been shown and described in detail, other modifications, which are within the scope of this invention, will be readily apparent to those of ordinary skill in the art based upon this disclosure. It is also contemplated that various combinations or subcombinations of the specific features and aspects of the embodiments may be made and still fall within the scope of the invention. Furthermore, the processes described herein may be embodied in hardware, in a set of program instructions—software, or both, i.e., firmware. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above.

What is claimed is:

1. A method of tracking and controlling documents, each document comprising one or more pages, the method comprising the steps of:
receiving a new tracking identifier;
generating a page of a second document based on a page of a first document, wherein the first document page comprises an old tracking identifier associated with the first document page and the first document, wherein the second document page comprises the new tracking identifier associated with the second document page and the second document, wherein the step of generating further comprises replacing the old tracking identifier with the new tracking identifier;
associating the old tracking identifier with the new tracking identifier; and
recording the association between the old tracking identifier and the new tracking identifier.

2. The method of claim 1 further comprising the steps of:
receiving another tracking identifier;
generating a page of a third document based on the second document page wherein the another tracking identifier is associated with the third document page and the third document, and wherein the step of generating further comprises replacing the new tracking identifier with the another tracking identifier; and
associating the new tracking identifier with the another tracking identifier;
recording the association between the new tracking identifier and the another tracking identifier.

3. The method of claim 1 further comprising the step of:
determining the old tracking identifier from the first document page.

4. The method of claim 3 wherein the determining step is via a barcode reader.

5. The method of claim 1 wherein the step of generating comprises generating a hardcopy.

6. The method of claim 1 wherein the step of generating comprises generating a softcopy.

7. The method of claim 6 wherein the second document comprises only one tracking identifier comprising the new tracking identifier.

8. The method of claim 6 wherein the second document comprises two or more tracking identifiers, one for each page of the second document.

9. The method of claim 6 wherein the second tracking identifier is embedded in the second document as metadata.

10. The method of claim 5 wherein the new tracking identifier in the generated second document page is embodied as at least one of the following:
a barcode;
a digital signature;
a watermark;
magnetic ink recognizable characters;
steganographic characters.

11. The method of claim 6 further comprising the steps of:
authenticating a storage device by determining whether the storage device is authorized to store the second document page;
if the storage device is an authorized storage device, then storing the second document page on the storage device.

12. The method of claim 11 wherein the authenticating step is based on whether the storage device is a removable storage device.

13. The method of claim 6, further comprising the steps of:
storing the second document page onto a storage device; and
storing a first locking code associated with the second document page onto the storage device.

14. The method of claim 13, further comprising the steps of:
receiving a second locking code;
verifying if the second locking code matches the first locking code; and
if the second locking code matches the first locking code, then performing a file operation on the stored second document page.

15. The method of claim 6, further comprising the steps of:
encrypting the generated second document page; and
storing the encrypted generated second document page.

16. The method of claim 1, further comprising the steps of:
determining the old tracking identifier of the second document page;
performing a destruction operation on the second document page;
transmitting the old tracking identifier and an indicator indicating destruction of the second document page; and
recording the old tracking identifier.

17. The method of claim 16, wherein the destruction operation is one of the following:
shredding the second document page;
deleting the second document page from a storage device.

18. A method of tracking and controlling documents, each document comprising one or more pages, the method comprising the steps of:
determining a tracking identifier embedded in a page of a document, wherein the tracking identifier is associated with the document page;
performing a destruction operation on the document page;
transmitting the tracking identifier and an indicator indicating destruction of the document page; and
recording the tracking identifier.

19. The method of claim 18, wherein the destruction operation is one of the following:
shredding the document page;
deleting the document page from a storage device.

20. A device comprising:
a communication module adapted to:
communicate with a tracking server;
receive a new tracking identifier from the tracking server associated with a second document page; and
transmit an old tracking identifier associated with a first document page;
a tracking identifier module adapted to:
determine the old tracking identifier embedded within the first document page; and
a reproducing module adapted to
generate the second document page based on the first document page by replacing the determined old tracking identifier with the received new tracking identifier, wherein the second document page comprises the new tracking identifier.

21. The device of claim 20 wherein the reproducing module is further adapted to generate the second document page by printing.

22. The device of claim 20 wherein the reproducing module is further adapted to generate the second document page by creating a softcopy and storing the softcopy in a data store.

23. A device adapted to be operably coupled to a network, the device comprising:
a tracking identifier module adapted to determine a tracking identifier embedded within a page;
a communication module adapted to communicate the determined tracking identifier to a tracking server adapted to maintain tracking identifiers; and
a destruction module adapted to perform a destruction operation on the page.

24. The device of claim 23 wherein the destruction operation is a shredding operation.

25. The device of claim 23 wherein the destruction operation is an operation adapted to delete the page from a storage device.

26. The device of claim 23 wherein the tracking identifier module is one of the following:
a bar code reader adapted to determine the tracking identifier embedded within the hardcopy page as a barcode;
an image reader module adapted to determine the tracking identifier embedded within the hardcopy page as one of the following:
a digital signature;
a watermark;
steganographic characters;
a magnetic ink character recognition module adapted to determine the tracking identifier embedded within the hardcopy page as magnetic ink characters.

27. The device of claim 23 wherein the communication module is further adapted to receive a new tracking identifier; and wherein the device further comprises
a printing module adapted to:
print a hardcopy document based on an input document, wherein the printed hardcopy document is based on the input document and replacing an old tracking identifier of the input document with the received new tracking identifier.

28. A system comprising:
a first device comprising:
a communication module adapted to:
communicate with a tracking server;
receive a new tracking identifier from the tracking server associated with a second document page; and
transmit an old tracking identifier associated with a first document page;
a tracking identifier module adapted to:
determine the old tracking identifier embedded within the first document page; and
a reproducing module adapted to
generate the second document page based on the first document page by replacing the determined old tracking identifier with the received new tracking identifier, wherein the second document page comprises the new tracking identifier; and
the tracking server comprising:
a tracking communication module adapted to:
transmit the new tracking identifier; and
record an association between the old tracking identifier and the new tracking identifier.

29. The system of claim 29 further comprising:
a second device comprising:
a tracking identifier module adapted to:
determine a tracking identifier embedded within the second document page;
a communication module adapted to:
communicate the determined tracking identifier within the second document page by the second device to the tracking server;
a destruction module adapted to:
perform the destruction operation on the second document page; and
wherein the tracking communication module of the tracking server is further adapted to:
receive the determined tracking identifier within the second document page by the second device; and
record an association between the determined tracking identifier within the second document page by the second device and the performed destruction operation.
